(19) United States
(12) Patent Application Publication
(10) Pub. No.: US 2003/0125969 A1
(43) Pub. Date: Jul. 3, 2003

(54) Method and apparatus for processing financial transactions over a paging network

(75) Inventors: Robert Dale Kizer, Manor, TX (US); John Franklin Terry, Plano, TX (US); James Danton Chadwick, Austin, TX (US)

Correspondence Address: BAKER & MCKENZIE, PATENT DEPARTMENT, 2001 ROSS AVENUE, SUITE 2300, DALLAS, TX, 75201, US

(73) Assignee: Wireless Checking, Inc.

(21) Appl. No.: 10/035,030

(22) Filed: Dec. 28, 2001

(51) Int. Cl. G06F 17/60

(52) U.S. Cl. 705/1

(57) ABSTRACT

One aspect of the invention is a method for receiving a financial transaction request in the form of a paging message and processing the financial transaction request according to a specific set of instructions. The method may include the steps of receiving a financial transaction request in the form a paging message, processing the financial transaction request to determine if sufficient funds are available to execute the transaction, executing the financial transaction, sending a transaction confirmation message in the form of a paging message, and generating an ACH file that includes the requested financial transaction. Another aspect of the invention is a transaction processor system adapted receive and process financial transactions requests by using the steps described above. Yet another aspect of the invention is a computer program product suitable for execution on a general purpose computer, wherein the computer program product comprises instructions for receiving and processing financial transaction requests according to the steps described above.

### BACKGROUND OF THE INVENTION

The present invention relates to the use of a paging network to execute financial transactions. The invention encompasses many aspects, including a method for receiving financial transaction requests in the form of paging messages and processing the financial transaction requests according to a specific set of instructions. Another aspect of the invention is a transaction processor system adapted to receive and process financial transaction requests in the form of a paging message. Yet another aspect of the invention is a computer program product suitable for execution on a general purpose computer wherein the computer program product comprises instructions for receiving and processing financial transaction requests in the form of a paging message.

A variety of financial transaction processing systems are well known, such as credit card systems, debit card systems, automatic teller machines and smart cards. Each of these systems has significant limitations which inhibit their effectiveness for executing financial transactions. For example, debit and credit card systems that are linked to a customer's bank account can cause the account to become overdrawn because they do not maintain a continuously updated balance of the customer's account. This problem is exacerbated when a customer writes checks or makes withdrawals directly from his/her banks account because the credit/debit card system will not know of these adjustments to the bank account until these transactions are cleared through the bank's system.

Another limitation of known financial transaction processing systems is that many of these systems require a customer to use equipment that is at a fixed location, such as an automatic teller machine, a smart card reader, or a merchant's point-of-sale device, in order to execute financial transactions. This limits the ability of a customer to execute financial transactions in a variety of locations or execute transactions while moving from location to location.

There is a therefore a need for a financial transaction processing system that allows a customer to access accurate information about his/her bank account in real-time. Specifically, A need exists for a system in which information about a customer's bank account can be updated in real-time to reflect financial transactions that have transpired during the day. A need also exists for a financial transaction processing system that is highly mobile, thereby allowing a customer to execute financial transactions without being tied to equipment at a fixed location, such as an automated teller machine.

### SUMMARY OF THE INVENTION

The invention disclosed herein is a method and apparatus for processing financial transactions over a paging network. A high level description of one aspect of the invention is illustrated in FIG. 1. In FIG. 1, a two-way paging device 100 is shown to be in communication with one of three radio towers 105. It is contemplated that the two-way paging device 100 is portable and may fall within the range of different radio towers 10 5 from time to time. Each of these radio towers 105 is connected to a transmitter 110, which provides power and paging messages to be broadcast from the tower. Each of the transmitters 110 is connected to a system controller 115, which is used to provide queuing, batching, encoding and scheduling of paging messages to be transmitted. The system controller 115 is also connected to a paging terminal 120, which acts as an entry point to the paging network from an external network. The paging terminal 120 may be used for accepting and validating paging messages from outside the paging network and forwarding those messages to other subsystems within the paging network. A subscriber database 125 is connected to the paging terminal 120 and is used to store information about subscribers to the paging network. A paging network gateway 130 is also connected to the paging terminal 120 and is used to convert paging messages received from an external network into a format that is usable by the paging network. Connected to the paging network gateway 130 is a transaction processor 135 that authenticates and executes many of the financial transactions requested by a user. The transaction processor 135 may be connected to the paging network gateway 130 either directly, or though a computer network 140, such as the Internet. The transaction processor 135 is also connected to a processor network 145 and to a partnering bank 150. In this manner, the transaction processor 135 may transmit information about pending financial transactions to other merchant accounts and may approve and disapprove transaction requests from merchant point-of-sale devices.

In one aspect of the invention, the transaction processor 135 is comprised of several elements including a router 200, a transaction server 205, a domain name (DNS) server 210, an e-mail server 215, a database server 220 and a network 225 connecting those elements. In general the transaction processor 135 receives financial transaction requests from the paging network and processes those requests. The transaction processor is also connected to a processor network 145 so that it can receive financial transaction requests from merchants or other third parties. The transaction processor 135 is adapted to receive a variety of financial transaction requests from the two-way paging device 100, including balance transfers, balance updates, payments to merchants, payments to other account holders, and deposits from other account holders. The transaction processor 135 determines if the transaction should be approved or disapproved, usually based upon the balance of the customers' account. In general, the transaction processor will provide messages to the customer and to the merchant indicating whether the transaction is approved or denied. These messages will be forwarded over the paging network or processor network as appropriate. If the transaction has been approved, then the customer's account will be credited or debited with an appropriate amount. If the transaction is not approved, then the transaction processor 135 will usually record information about the transaction request in a history file. At the end of each banking day, the transaction processor 135 will generate an ACH file describing each of the financial transaction executed during the past day. This ACH file will usually be forwarded to a partnering bank so that it can be transmitted to an ACH network, such as the Federal Reserve Network 155 or an automated clearing house 160. However, it is contemplated that the transaction processor may be directly connected to an ACH network so that the ACH files may be directly uploaded and reconciled.

By using a two-way paging device to execute financial transactions over a paging network, the customer can always see how much money remains in his/her bank account. Furthermore, because the two-way paging device is highly mobile, it can be used to execute financial transactions from any location within the paging network's service area. In addition, the two-way paging device will always have the most recent information about a customer's account because the transaction processor 135 is linked directly to the partnering bank 150 where the customer's account resides. This information can be downloaded to a two-way paging device 100 through the paging network. This allows a customer to review not only transactions that have been executed over the past several days, but also those transactions that are processed during each day. Another aspect of the invention contemplates that the two-way paging device will be the sole means by which a customer can access funds in his/her bank account. In this manner, the customer cannot overdraw the account because the transaction processor 135 will deny any transaction that would overdraw the account. This has an advantage over debit card and credit card systems because those systems only update a customer's bank account balance once a day, thus allowing overdraft conditions to exist.

One aspect of the invention is a method of processing financial transaction requests received from a paging network with a transaction processor comprising a network interface server, a transaction server, a database server, and a message server, the method comprising the steps of:

receiving a financial transaction request in the form of an encrypted paging message at the network interface server, said paging message comprising a set of transaction data including a routing number, an account number, a transaction amount, a security code and a paging unit ID number;

decrypting the paging message at the message server;

comparing each data field within the set of transaction data with a corresponding data field standard from the database server to determine if the format of the data fields are acceptable for processing;

if any of the data fields do not have an acceptable format, then performing the following steps a) through d);

a) generating a transaction denied paging message corresponding to the reason why the transaction was denied;

b) identifying a paging unit address that corresponds to a paging unit ID number within the set of transaction data;

c) encrypting the transaction denied paging message;

d) sending the encrypted transaction denied paging message to the paging unit address;

if all of the data fields have an acceptable format, then performing the following steps e) through j):

e) assigning the transaction request a transaction reference number;

f) storing the set of transaction data, the transaction reference number, and an approval flag in a temporary transaction table in the database server;

g) retrieving a set of account data and a set of customer data from the database server, both of which correspond to the account number in the set of transaction data;

h) comparing a security code from the set of transaction data with a security code from the corresponding set of customer data to determine if an acceptable security code has been provided;

i) if an acceptable security code has not been provided, then performing the transaction denied routine designated above as steps a) through d);

j) if an acceptable security code has been provided then performing the following steps l) through n):

l) comparing a transaction amount from the set of transaction data with a balance amount from the corresponding set of account data to determine if sufficient funds are available for the requested financial transaction;

m) if sufficient funds are not available for the requested financial transaction, then performing the transaction denied routine designated above as steps a) through d);

n) if sufficient funds are available for the requested financial transaction, then performing the following steps o) through s):

o) activating the approval flag in the set of transaction data;

p) generating a transaction approved paging message comprising a plurality of data fields including an account balance data field;

q) identifying a paging unit address that corresponds to a paging unit ID number within the set of transaction data;

r) encrypting the transaction approved paging message;

s) sending the encrypted transaction approved paging message to the paging unit address;

transferring all sets of transaction data in which the approval flag has been activated from the temporary transaction table to a transaction table in the database server;

transferring all sets of transaction data in which the approval flag has not been activated from the temporary transaction table to a history table in the database server; and

exporting the transaction table into an ACH file for transmission to an ACH network.

Another aspect of the invention is a computer program product suitable for execution on a general purpose computer, the computer program product encoded with instructions for performing the steps described above.

Yet another aspect of the invention is a transaction processor comprising the following elements:

a network interface electrically connected to a paging network;

a transaction server electrically connected to the network interface and to a processor network, wherein the transaction server is adapted to process financial transaction requests;

message server electrically connected the network interface and the transaction server, wherein the message server is adapted to receive inbound paging messages from the network interface, and generate outbound paging messages for transmission through the network interface to the paging network;

a database electrically connected to the transaction server and the message server, the database comprising a computer memory encoded with a relational database including an account table, a transaction table, a temporary transaction table, and a history table; and

a computer memory product encoded with instructions for performing the steps described above.

### BRIEF DESCRIPTION OF THE DRAWINGS

FIG. 1 is a high-level view of one aspect of the invention, which is a paging network connected to a transaction processor, which is connected to processor network and a partnering bank.

FIG. 2 is a block diagram depicting some of the components of a transaction processor and how those components are connected to a processor network and to a partnering bank.

FIG. 3 is an illustration of a relational database that may be stored in a database in the transaction processor suitable for use with the invention.

FIG. 4 is a flowchart depicting some of the steps utilized by one aspect of the invention for receiving and processing a financial transaction request in the form of a paging message.

FIG. 5 is a flowchart depicting some of the steps utilized by one aspect of the invention for receiving and processing a financial transaction request in the form of a paging message.

FIG. 6 is a flowchart depicting some of the steps by which a financial transaction request is processed by the paging network and by the transaction processor.

FIG. 7 is an illustration of the process flows and the typical delays for settling ACH transactions between banks.

### DETAILED DESCRIPTION OF THE INVENTION

The Paging Network

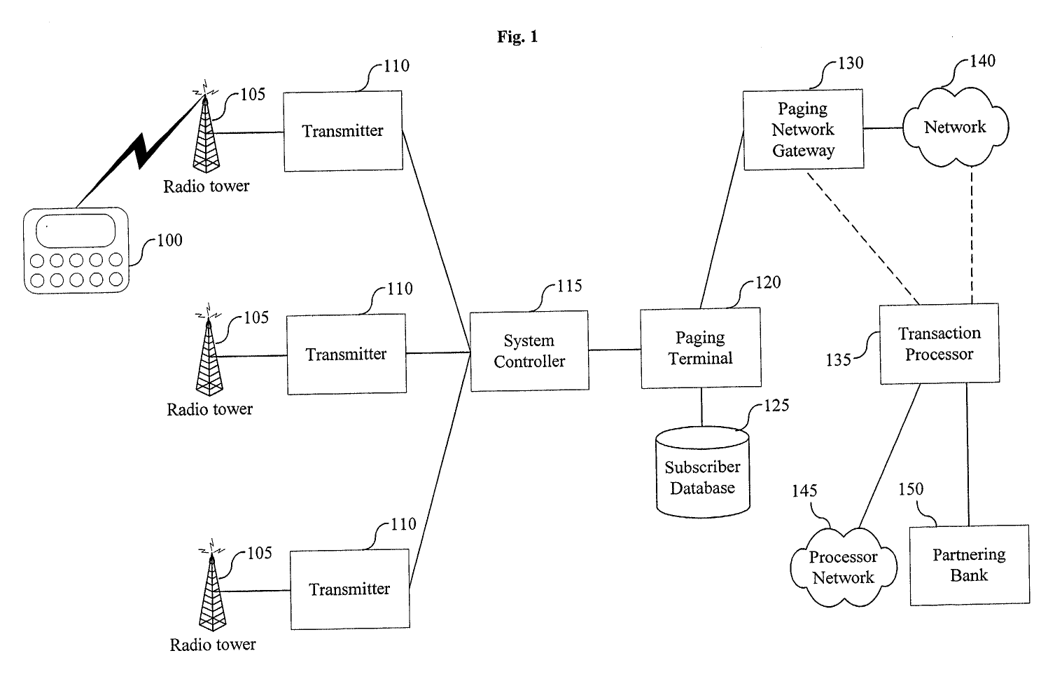

The components of a typical paging network illustrated in FIG. 1 and are summarized in the following paragraphs. The components of the paging network depicted in FIG. 1 are a two-way paging device 100, a series of radio towers 105, a series of transmitters 110 connected to the radio towers 105, a system controller 115, a paging terminal 120, a subscriber database 125, and a paging network gateway 130. It should be noted that FIG. 1 depicts only one embodiment of a paging network and that many different arrangements of components will form a paging network suitable for use with the disclosed invention.

In FIG. 1, a two-way paging device 100 is depicted. The two-way paging device 100 may be any paging device that allows a user to receive paging messages, enter information into the pager, and transmit that information over a paging network. In one embodiment of the invention, the paging device includes a keyboard and a display screen capable of displaying several lines of text. By using the keyboard and display, a user may enter information into the pager for transmission to the paging network. The display screen also allows a user to view textual information sent to the paging unit from the paging network. The two-way paging device 100 will have at least one unique address associated with it called a capcode or RIC (radio identification code). A capcode is a code that is embedded in all paging messages that identifies which paging device is to receive a paging message. Thus, when a paging message is broadcast from a radio tower, only those paging devices that are coded with a corresponding capcom will receive the paging message. By assigning more than one capcom to a paging device, a paging device may receive paging messages directed to groups of paging devices as well as to individual pagers. In one embodiment of the invention, the two-way paging device 100 includes an encryption processor that encrypts the text of a paging message before it is transmitted over paging network. Because only the sender and receiver of the paging message will be able to decrypt the paging message, transmission of the paging message over a public paging network will be secure.

The radio towers 105 are the transmission points for broadcasting the paging messages. Generally, these towers operate in the range of less than 100 watts to around 300 watts and are located over a wide geographic area in order to provide adequate service coverage. Typical commercial paging networks include hundreds of radio towers. Each radio tower 105 is connected to a transmitter 110, which is usually located at the site of the radio tower 105. Several radio towers 105, however, may be connected to only one transmitter 110. Transmitters 110 handle the scheduling and transmission of out bound paging messages from the radio towers 105 as well as the reception and forwarding of inbound paging messages. Each transmitter 110 is designed to operate in a specific frequency range, depending upon the spectrum allocation for the transmitter operator. The bandwidth of a typical transmitter/radio tower combination is relatively low, typically ranging from 1200 to 6400 bps on each outbound RF channel. Effective data rates for these transmitters can be even lower because over-the-air protocols include overhead for encryption, batching, error detection and correction, and packet allocation. Low bandwidth is not a problem for most paging systems because they are designed to transmit and receive short, text-based messages. Modem paging transmitters 110 may either be linear or Frequency Modulated (FM). FM transmitters broadcast on a single frequency at a time and tend to be much less expensive. Linear transmitters, however, have an advantage because they can broadcast on multiple frequencies at the same time. Either type of transmitter may be used with the invention disclosed herein. Transmitters 110 may also be designed to support operations and maintenance functions as well as paging functions. Specifically, transmitters 110 should be able to accept configuration changes and new software downloads. These changes may be broadcast over existing paging infrastructure, or through dial-up links with a central system.

Transmitters 110 are configured to receive paging messages from a system controller 115 and broadcast them at the time assigned by the system controller 115. Accordingly, the transmitters 110 must be designed to support the message distribution protocol used by the system controller 115. At the appropriate time, the transmitter will key up a scheduled paging message, encode it according to the appropriate over-the-air protocol, and broadcast it at the precise time indicated by the system controller 115. Broadcasting the paging message at a precise time is very important for paging systems to avoid interference with transmissions from other radio towers 105.

Another function that is performed by a transmitter 110 is a receiving function. The receiving function is necessary to process incoming paging messages received from a two-way paging device 100. Much like the transmitting functions, the receivers must be adapted to process a paging message according to the over-the-air protocol used by the two-way paging device 100. In addition, the receiving apparatus is designed to operate in a specific frequency range and have a very high sensitivity so as to detect paging messages transmitted from low-power paging devices 100.

System controllers 115 are connected to the transmitters 110 and are used to queue, encode and schedule out bound paging messages for delivery to the transmitter sites 110. System controllers 115 also handle processing of two-way inbound messages that are transmitted by the two-way paging devices 100. The system controller's 115 primary task is to manage the distribution of outbound paging messages to the transmitters 110 so as to optimize the use of the distribution links and the radio frequency spectrum. This optimization can be implemented with a variety of well-known message distribution protocols. These distribution protocols are used to facilitate scheduling and error detection and correction for the paging messages.

In order to prevent interference between different radio towers 105, the system controller 115 must compute “launch times” corresponding to each respective radio tower 105. The launch time for each tower 105 accounts for the time it takes to send a paging message across the distribution network to the transmitter 110. This launch time is sent to each transmitter 110 along with the paging message to be broadcast. Ideally, the paging message is transmitted to each respective radio tower 105 just before the designated launch time so that the transmitter 110 has time to process the message and send it to the transmitter's power amplifier at precisely the right time. If the message arrives too early, it must be stored in the transmitter's input queue, possibly causing overflow. If the message arrives too late, then the message will not be transmitted.

In two-way paging systems, the system controller 115 also plays an important role in locating subscribers and processing inbound paging messages. Whenever a two-way paging device enters the service area of a radio tower 105, information about the location of a the two-way paging device 100 is stored in the system controller 115. Thus, when a paging message is to be delivered to a particular two-way paging device 100, its location may be determined by referencing information stored in the system controller 115. With respect to inbound paging messages, the system controller may also be adapted to schedule inbound paging messages. Although it is possible to handle these inbound messages as randomly generated messages, similar to the way that an Ethernet LAN works, it is generally more efficient to schedule them. By scheduling inbound messages, collisions are minimized and the use of inbound RF channels is optimized. Both of these functions are handled by the system controller 115. The system controller 115 may also encode, transmit and receive system management and control messages over the same paging infrastructure that paging messages are transmitted. These management and control messages include sending configuration information, requesting and receiving diagnostic information, and downloading new software to the transmitters and receivers.

As stated above, the paging terminal 120 is the entry point to the paging network from external networks. Accordingly, it is used to receive and validate paging message requests from external networks. The paging terminal 120 is also used to perform administrative services such as message forwarding and billing. In general, paging messages can originate from many different sources, most common of which has been the public switched telephone network (PSTN). However, the introduction of two-way and alpha-numeric paging have greatly expanded the input sources for originating paging messages to include other two-way pagers, operator-assisted paging systems, e-mail and Internet sites. The paging terminal 120 is used to receive and process paging messages from all of these sources in order to ensure that these paging messages are processed appropriately.

The paging terminal 120 is connected to a subscriber database 125 in which data about the paging subscribers is stored. Each subscriber will generally be assigned a single “home” terminal which is where his/her service information or “profile” is stored. Subscriber profiles include personal identification numbers, the kind of paging device used by the subscriber, the services that the subscriber may use, subscriber configuration parameters, and capcodes assigned to a subscriber. Subscriber configuration parameters may include options such as message storage, maximum message usage, passwords, custom greetings, and message forwarding.

One important function served by the paging terminal 120 is to translate a recipient's name in the paging message into a capcode corresponding to that recipient's paging device. The paging terminal 120 does this by referencing the subscriber database 125 upon receipt of a paging message directed to a particular user. The capcode may then be used by the paging system to locate a specific paging device 100 that is to receive the paging message. Upon receipt of a paging message, a paging terminal 120 will generally hold the message in its queue until the downstream system controller 115 is able to accept it. The paging terminal 120 may even store the message for later retrieval and re-transmission. For two-way paging systems, the paging terminal 120 may hold on to an outbound paging message for a preconfigured time until confirmation is received back from the two-way paging device 100. This feature is particularly useful where a system needs to confirm receipt of an important paging message by a user.

The paging terminal 120 may be connected to paging terminals associated with other paging networks. In this manner, a paging message may be broadcast over several paging networks, greatly expanding the service area of the two-way paging device 100.

As the paging terminal 120 must be able to connect to a variety of input systems, the use of a paging network gateway 130 is sometime necessary. The paging network gateway 130 converts the format of a paging message request from any of a variety of formats into a format that is processable by the paging terminal 120. Specifically, the paging network gateway 120 can be configured to convert paging requests from a variety of Internet-based protocols (SMTP, HTML, HTTP, HTTPS, etc.) into an appropriate format.

Although the features of the transmitter 110, system controller 115, paging terminal 120, subscriber database 125, and paging network gateway 130 are described separately above and are illustrated separately in FIG. 1, the functions and features of these components may be consolidated a single device, or a number of devices less than those shown.

A transaction processor 135 is shown in FIG. 1 connected to the paging network gateway 130. The transaction processor 135 is used to process financial transaction requests received from the paging network and generate paging messages to be sent to specific paging devices 100. Requests for financial transactions can be sent to the transaction processor 135 directly from the paging network gateway 130 or through a computer network 140, such as the Internet. The transaction processor 135 is also connected to a partnering bank 150 so that information about a user's account may be downloaded directly to the transaction processor 135. Because the transaction processor 135 always has accurate information about the balance of a user's account, it can accurately process financial transactions without overdrawing the user's account. The transaction processor 135 is further connected to a processor network 145 so that requests for financial transactions can be sent from the transaction processor 135 to other merchant accounts. The processor network 145 may also be used to receive and reconcile financial transactions from other merchant accounts.

Transmission of an Inbound Paging Message through the Paging Network

The details of how a paging message is transmitted from a two-way paging unit 100 to the transaction processor 135 (an inbound paging message) is summarized below. First, the user enters a requested financial transaction into the two-way paging device 100. Depending upon the specific embodiment employed, a requested financial transaction request will include information about the transaction such as the routing and account number for the payee's account, the routing and account number for the user's account, a transaction reference number, a transaction amount, a paging unit ID number, and a security code corresponding to the user. This information is arranged in the text of a paging message according to a particular protocol and is transmitted by the paging device 100. The paging message is received by the nearest radio tower 105 and is forwarded to the corresponding transmitter device 110. The transmitter 110 processes the inbound paging message and forwards it to the system controller 115. The system controller 115 assembles all of the inbound paging messages received from the radio towers 105 and schedules them for forwarding to the paging terminal 120. After receiving an inbound paging message from the system controller 115, the paging terminal 120 identifies an address corresponding to the recipient of the paging message and forwards the~paging message to that addressee. In one aspect of the invention, the paging terminal 120 converts the paging message into an e-mail message that is sent to the e-mail address of the recipient. In another aspect of the invention, the paging message is uploaded to a transaction processor 135 that is directly connected to the paging terminal 120. In the embodiment depicted in FIG. 1, an inbound paging message can be forwarded from the paging terminal 120 to the paging network gateway 130, through a computer network 140 (i.e. the Internet) to the transaction processor 135, which is the intended recipient of the paging message.

Transmission of an Outbound Paging Message through the Paging Network

The details of how a paging message is transmitted from the transaction processor 135 to a two-way paging unit 100 is summarized below. First, the transaction processor 135 will generate a paging message to be sent to the paging terminal 120. This paging message may be used to deliver a variety of information about a user's bank account such as balance information, account updates, transaction approval, or transaction denied messages. All of the relevant account information is arranged in the text portion of a paging message according to a particular protocol and is forwarded to the paging terminal 120. As shown in FIG. 1, the transaction processor may be connected to the paging terminal 120 in several different ways, such as connection to a paging network gateway 130 through a computer network 140, direct connection to a paging network gateway 130, or by direct connection to a paging terminal 120. Furthermore, the paging message may be transmitted using a variety of protocols including e-mail, secure e-mail, HTTP, HTTPS, and FTP. After the paging message is received by the paging network gateway 130, it is converted into a format that is processable by the paging network. After this conversion, it is forwarded to the paging terminal 120. At the paging terminal 120, the addressee of the paging message is cross-referenced with an entry in the subscriber database 125 to identify a capcom associated with the addressee. Using this information, the paging terminal 120 queries the system controller to determine the most recent location of the paging unit 100 that is to receive the paging message. This step may include sending a network-wide “where are you” message to all radio towers 105 to determine which radio tower 105 is closest to the paging unit. This “where are you” transmission is answered by the paging unit 100 and the response is forwarded by the transmitter to the paging terminal 120. After determining the closest radio tower 105 to the paging unit 100, the paging terminal 120 forwards paging message, with the capcom number, to the system controller 115 with instructions to transmit the paging message from the closest radio tower 105. The system controller 115 then schedules the paging message for transmission by the appropriate radio tower 105 and forwards this information to the appropriate transmitter 110. At the scheduled time, the paging message is broadcast by the radio tower 105 to the two-way paging device 100. Generally, the paging device 100 will transmit a receipt confirmation back to the paging network indicating that the paging message has been received. This confirmation is forwarded back to the paging terminal 120 where it may be stored (in the subscriber database) or forwarded to the transaction processor 135.

The Transaction Processor

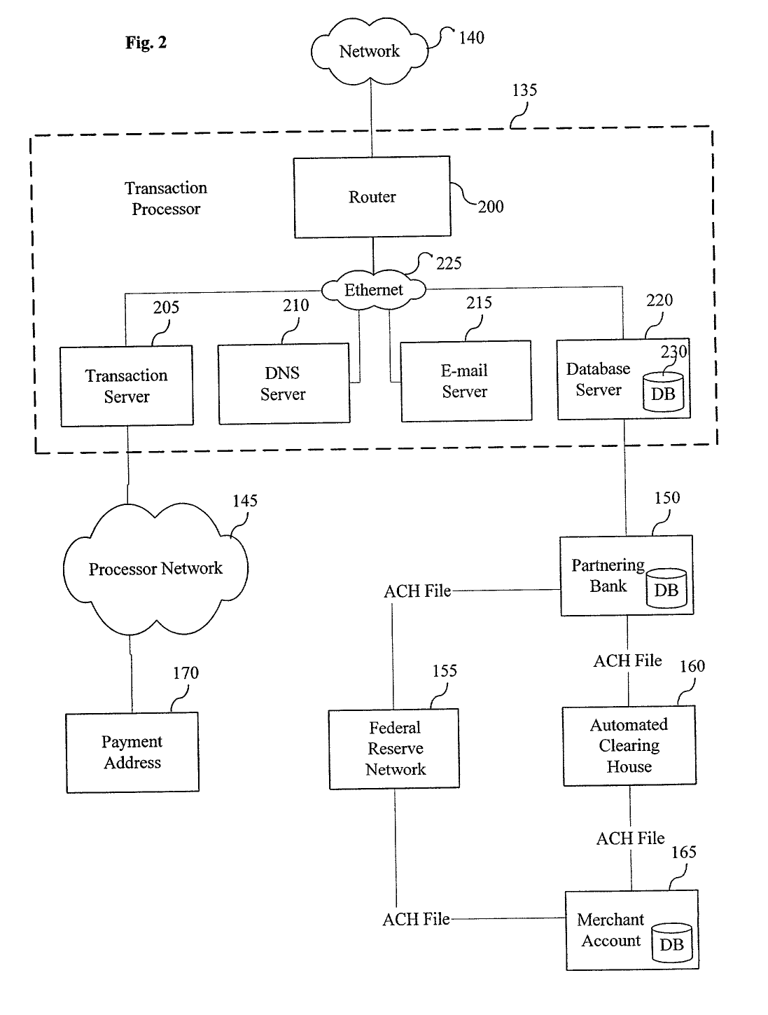

The transaction processor represents the part of the system in which the financial transaction requests are processed. The components of one embodiment of a transaction processor 135 are depicted in FIG. 2 and are summarized in the following paragraphs. It should be noted that FIG. 2 depicts only one embodiment of a transaction processor 135 and that many different arrangements of components will form a transaction processor 135 suitable for use with the disclosed invention.

The transaction processor of FIG. 2 is comprised of five components: a router 200; a transaction server 205; a DNS server 210; an e-mail server 215; and a data base server 220. Each of these components is disclosed as being connected to each other through a computer network such as an ethernet connection 225. Although FIG. 2 depicts the transaction processor as comprising five separate components, these components may be consolidated into one or more units or servers. Each of these components is described in further detail below.

The router 200 acts as the gateway between the transaction processor 135 and an external network 140. Accordingly, for inbound paging messages, the router receives the message from the network 140 and forwards it to the appropriate server for further processing. For outbound messages, the router forwards the paging message from the appropriate server to the computer network 140 so that it may be received by the paging network.

The transaction server 205 processes each of the financial transaction requests received from the paging network. The transaction server 205 is also used to reconcile transaction information that it receives from the processor network 145. The specific processes utilized by the transaction server 205 will be described in further detail below.

The DNS server 210 is used to maintain the transaction processor's 135 presence on the Internet. This includes maintaining a database of Internet domains to which paging messages may be sent. Accordingly, the DNS server 210 is used to tell the router 200 where to forward paging messages so that they may be correctly processed by the paging network.

The e-mail server 215 is used in an embodiment where paging messages are sent to and received from the transaction processor 135 in the form of e-mail messages. It is contemplated that the e-mail server 215 will use SMTP format for the e-mail messages so that these e-mail messages may be readily processed over the Internet.

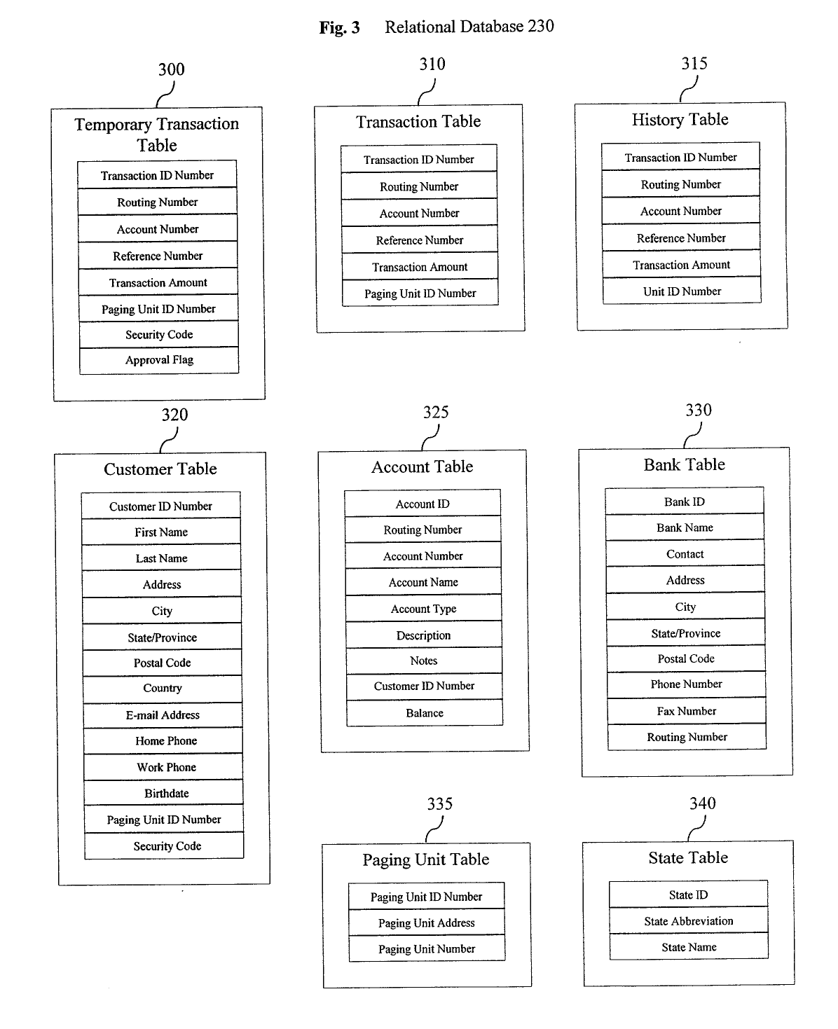

The database server 220 maintains a database 230 in which user account information is stored. In one embodiment of the invention, the database 230 is a relational database including many interrelated tables and fields, such as the database disclosed in FIG. 3. The database server 220 is also connected to a partnering bank 150 so that the account information for the users of the system may be updated periodically. In this manner, the data base server 220 will have the most recent information about a user's bank account available for use by the transaction server 205.

In FIG. 2, several additional components are disclosed as being interconnected to the transaction processor 135. These components are the processor network 145, a partnering bank 150, the Federal Reserve Network 155, an automated clearing house 160, a merchant account 165, and a payment address 170. These components are described below.

The processor network 145 is connected to the transaction server 205, and it is used to facilitate the approval or denial of transactions between users and various third parties. For example, if a user is at a merchant's retail establishment and transmits a request for a financial transaction from his two-way paging device 100, that transaction request will eventually be forwarded to the transaction server 205 within the transaction processor 135. According to one embodiment, the merchant will simultaneously transmit a corresponding request for approval of the transaction through his point-of-sale equipment. Some of the information necessary for the transaction may be entered into the merchant's point-of-sale device directly from the two-way paging device 100 by using any of variety of methods, including RF signaling (using protocols such as Bluetooth™, etc.), infrared beam, and bar code scanning. Otherwise, the merchant may manually enter the information required for the transaction (i.e. routing number, account number, IP address of the transaction processor, etc.) directly into the point-of-sale device. The point-of-sale device then sends a transaction approval request to the processor network 145. The merchant's approval request will include a payment address 170, which is an electronic address for the merchant's point-of-sale device. The merchant's request is forwarded through the processor network 145 to the transaction server 205. At this point, the user's transaction request may be either approved or denied based upon criteria such as the funds available in the user's account. The approval or denial information is forwarded to the user back through the computer network 140 and the paging network. Simultaneously, the appropriate approval or denial message will be transmitted by the transaction server 205 through the processor network 145 to the payment address 170. In this manner, both the user and the merchant will receive instant notification of the approval or denial of the transaction request.

In another embodiment, the transaction approval requests will be originated from the two-way paging device 100. To do this, the two-way paging device will first determine a payment address 170 associated with the merchant's point of sale device. This payment address 170 can be ascertained by the two-way paging device 100 in a variety of ways, including RF signaling (using protocols such as Bluetooth™, etc.), infrared beam, and bar code scanning. The payment address may also be manually entered into the two-way paging device 100 through its keyboard. After determining the payment address 170, the two-way paging device 100 will transmit a transaction approval request through the paging network 140 to the transaction processor 135. The transaction processor 135 then determines if the transaction should be approved by analyzing the user's account balance, etc. If the transaction is approved, then a transaction approved message is transmitted to the two-way paging device 100 and to the merchant's payment address 170 at the same time. FIG. 2 demonstrates that the transaction approved message would be transmitted to the merchant's point-of-sale device over a processor network 145 in much the same way that a credit-card or debit-card transaction approved message would be transmitted. Similarly, the user's transaction approved message would be sent to the two-way paging device 100 through the paging network 140. If the transaction were denied by the transaction processor 135, then the transaction denied messages would be sent to the two-way paging device 100 and to the payment address 170 in the same way.

Continuing with the third-party transaction example, once the transaction is approved by the transaction server 205, a record of the transaction is recorded in the database 230 and an appropriate amount is debited from the user's account balance. Typically, a transaction approved message will be sent to the user's paging device 100 that includes information about the user's account balance after completion of the transaction.

At the end of each banking day, the database server 220 will compile all of the transactions executed by the user into an ACH file that is uploaded from the data base server 220 to the partnering bank 150. This ACH file will include information describing the amount of each executed transaction as well as the identification of each merchant to whom these amounts are to be paid. In FIG. 2 it can be seen that the partnering bank 150 will forward this ACH file to an appropriate ACH network, such as the Federal Reserve Network 155 or an automated clearing house 160, so that the appropriate amounts can be transferred from the partnering bank 150 to the merchant accounts 165. After these ACH files have been transferred and the partnering bank and merchant accounts have transferred any necessary funds, all of the user's accounts and merchant's accounts are considered to be settled. The processes by which the ACH files are transferred, reconciled and settled between banks will be described in further detail below.

The Relational Data Base in the Data Base Server

Another aspect of the invention is the relational database 230 that resides on the database server 220 in the transaction processor 135. One embodiment of a relational database 230 suitable for use with the invention is depicted in FIG. 3. It should be noted that FIG. 3 depicts only one embodiment of a relational data base 230 and that many different combinations and arrangements of the data fields and tables will form a relational data base 230 suitable for use with the disclosed invention. The relational database 230 disclosed in FIG. 3 comprises eight tables: a temporary transaction table 300; a transaction table 310; a history table 315; a customer table 320; an account table 325; a bank table 330; a paging unit table 335; and a state table 340.

According to one aspect of the invention, the temporary transaction table comprises several data fields such as a transaction ID number, a routing number, an account number, a reference number, a transaction amount, a paging unit ID number, a security code, and an approval flag. Similarly, a transaction table 310 may be comprised of data fields including a transaction ID number, a routing number, an account number, a reference number, a transaction amount, and a paging unit ID number. Similarly, a history table may be comprised of several data fields including a transaction ID number, a routing number, an account number, a reference number, a transaction amount and a paging unit ID number. Similarly, a customer table may be comprised of several data fields, including a customer ID number, a first name, a last name, an address, a city, a state/province, a postal code, a country, an e-mail address, a home phone, a work phone, a birth date, a paging unit ID number, and a security code. Similarly, an account table may be comprised of several data fields including an account ID, a routing number, an account number, an account name, an account type, a description, notes, a customer ID number and a balance. Similarly, a bank table 330 may be comprised of several data fields including a bank ID, a bank name, a contact, an address, a city, a state/province, a postal code, a phone number, a fax number, and a routing number. Similarly, a paging unit table 335 may be comprised of several data fields including a paging unit ID, a paging unit address, and a paging unit number. Similarly, a state table 340 will be comprised of several data fields including a state ID, a state abbreviation, and a state name. Each of the tables and the respective data fields in the relational database 230 are interrelated with each other so that modifications to the data fields in one table will instantaneously update the corresponding data fields in other tables. Although one embodiment of the relational database 230 is disclosed in FIG. 3, it is contemplated that a wide variety of other tables and data fields may be utilized for the disclosed invention.

Processing a Financial Transaction Request at the Transaction Processor

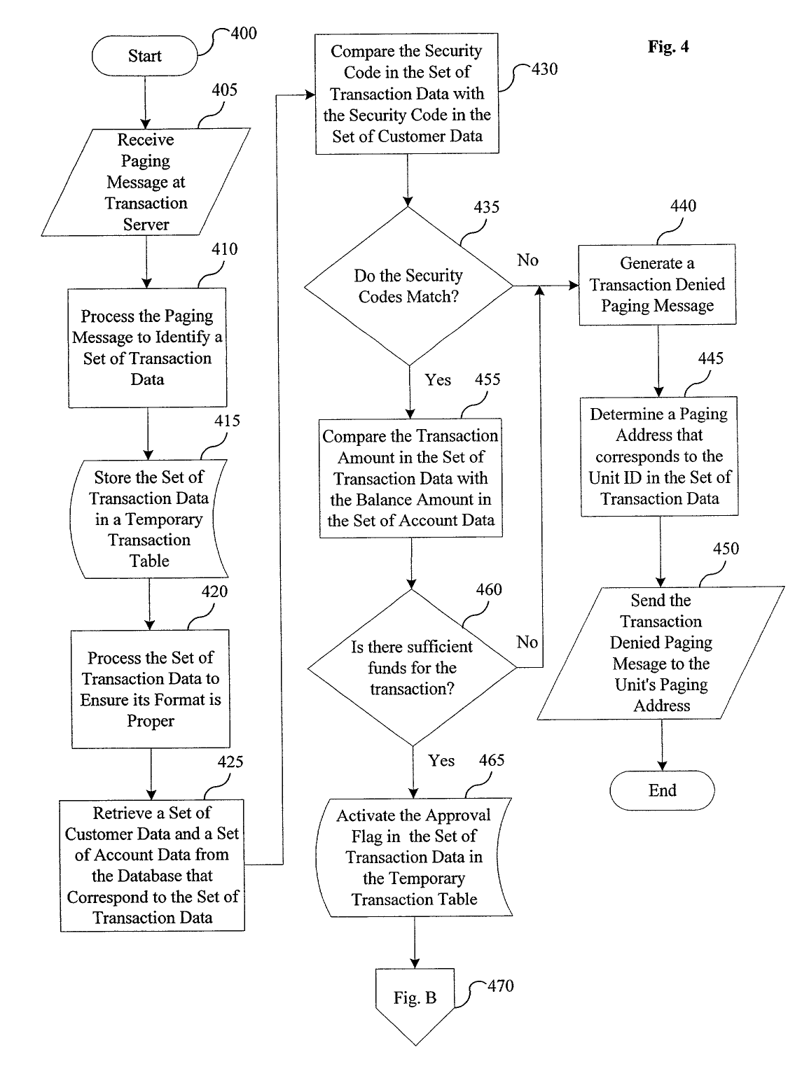

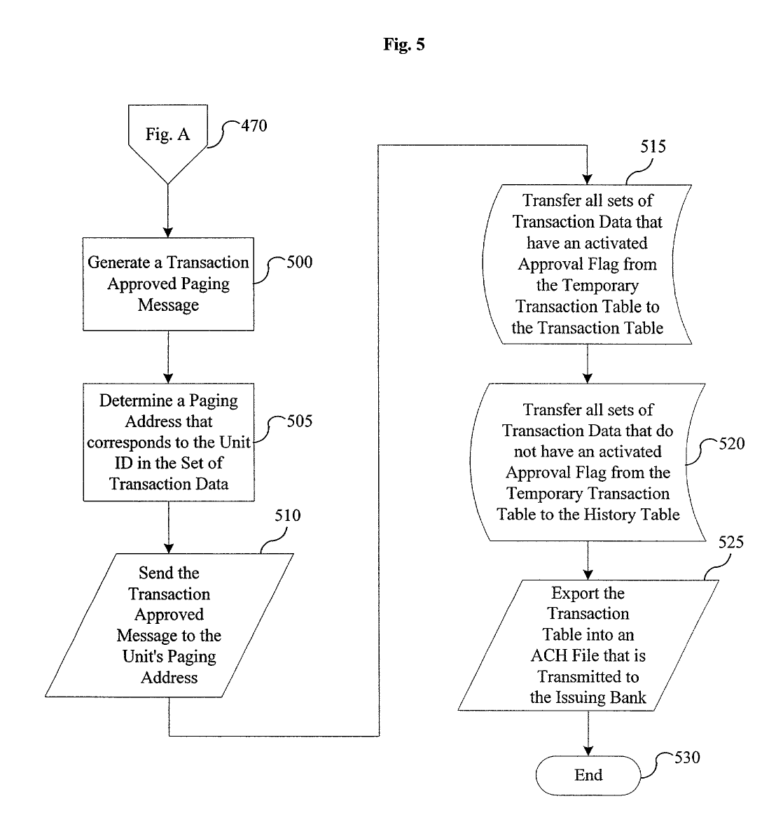

A process flow diagram depicting the steps used by the transaction processor upon receipt of a paging message is depicted in FIGS. 4 and 5. It should be noted that FIGS. 4 and 5 depict only one process by which the transaction processor may process incoming paging messages and that other process steps and flows are suitable for use with the disclosed invention.

The process starts at Step 400 when a paging message is received at the transaction server 405. With reference to FIG. 2, this step occurs which a paging message is received by the transaction processor 135 from the network 140 and is forwarded by the router 200 through the network 225 to the transaction server 205. The next step disclosed in FIG. 4 is to process the paging message so as to identify a set of transaction data 410. Although not depicted in FIG. 4, this step may require that the paging message be decrypted before it can be processed by the transaction server 205. A variety of encryption schemes may be used with this invention, including the well-known public key/private key encryption scheme. After the paging message is decrypted, the transaction server 205 will extract a set of transaction data from the paging message, as depicted by step 410 in FIG. 4. The set of transaction data identified in step 410 may include several data fields such as a transaction ID number, a routing number, an account number, a reference number, a transaction amount, a paging unit ID number, and a security code. In an embodiment in which paging messages are transmitted in the form of e-mail messages, these data fields will be arranged in the text portion of the e-mail according to a pre-defined protocol. The next step is to store the set of transaction data retrieved from the paging message in a temporary transaction table 300 as illustrated by step 415. After the set of transaction data is stored in the temporary transaction table 300, a test may be performed to determine if the format of the set of transaction data is proper. This is represented by Step 420 in FIG. 4. This format test includes verifying that the correct kind of data is stored in each data field (i.e. alpha numeric, numeric, and binary data) and that the size of the data in each data field does not exceed the maximum amounts allowed by the format requirements. Generally, if the set of transaction data in the temporary table 300 is not of the correct format, than this data will be discarded and a transaction denied message will be sent to the end user. The test for formatting correctness insures that the data contained within the paging message may be properly processed by the transaction processor 135. The steps for generating a transaction denied message will be further described below.

After the format of the set of transaction data has been verified, the transaction processor 135 will retrieve a set of customer data from a customer table 320 and a set of account data from an account table 325, both of which correspond to the set of transaction data stored in the temporary transaction table 300. These retrieval operations are represented by Step 425 in FIG. 4. Next, the transaction processor 135 may compare the security code in the set of customer data with the security code in the set of account data stored in the temporary transaction table. This is represented by Step 430 in FIG. 4. In one embodiment of the invention, the security code in the set of transaction data will be encrypted and must be decrypted before it can be compared to the corresponding security code in the set of customer data. This encryption/decryption step may use any of a variety of well-known encryption schemes, such as public key/private key. If the security codes do not match (Step 435), then the system will generate a transaction denied paging message, which is represented by Step 440.

When the transaction processor 135 generates a transaction denied paging message, it will first determine a paging address that corresponds to the paging unit ID number that is stored in the temporary transaction table 300. This operation is illustrated by Step 445 in FIG. 4. The paging address may be in the form of an e-mail address or a capcom, depending upon the specific embodiment employed. After determining the paging address, the transaction processor 135 will send a transaction denied paging message to the paging address. This is represented by Step 450 in FIG. 4. In one embodiment of the invention, the transaction denied paging message will include information as to why the transaction was denied (i.e., insufficient balance, improper format for the transaction data, etc.) It is contemplated that the transaction denied paging message may be in the form of an e-mail message directed to a user's two-way paging device 100. Depending upon the embodiment of the invention, a transaction denied message may also be simultaneously transmitted to a merchant's point-of-sale device through a processor network 145 as described above.

If the security code in the set of transaction data in the temporary transaction table 300 matches the security code in the set of customer data, then the transaction processor 135 will compare the transaction amount in the temporary transaction table with a balance amount in a set of account data from the account table 325. This is represented by Step 455 in FIG. 4. If sufficient funds are not available to process the transaction (Step 460), then the transaction processor 135 will generate a transaction denied paging message as described above (Step 440 et. seq.). If, on the other hand, sufficient funds are available for the transaction, then the transaction processor 135 will activate an approval flag in the temporary transaction table 300. This is represented by Step 465 in FIG. 4. The next step in this process is depicted in FIG. 5, as indicated by Step 470.

After the approval flag has been activated, the transaction processor 135 will generate a transaction approved paging message. This is represented by step 500 in FIG. 5. Next, the transaction processor 135 determines the paging address that corresponds to the paging unit ID number in the set of transaction data within the temporary transaction table 300. As stated above, this paging address may be in the form of an e-mail address or a capcom. This is represented by Step 505 in FIG. 5. After this, the transaction processor 135 sends the transaction-approved message to the previously determined paging address. This is represented by Step 510 in FIG. 5. The transaction approved message may include a variety of data other than the transaction approval (i.e. balance information, transaction amount, approval code, etc.). Again, depending upon the embodiment of the invention, a transaction approved message may also be simultaneously transmitted to a merchant's point-of-sale device through a processor network 145 as previously described.

Generally, once a transaction-approved message is sent to the user's paging device 100, no further action is required from the user. Several additional steps may be required at the transaction processor 135 in order to complete the financial transactions. These steps are illustrated in FIG. 5 as Steps 515, 520 and 525. At Step 515, the transaction processor 135 transfers all of the sets of transaction data in which the approval flag has been activated from the temporary transaction table 300 to the transaction table 310 in the database server 220. This step represents converting the requested financial transaction from a provisional status into an approved and executed status. Another step performed by a transaction processor 135 is to transfer all sets of transaction data in which the approval flag has not been activated from the temporary transaction table 300 to the history table 315 in the database server 220. This is represented by Step 520 in FIG. 5. The transfer of a set of transaction data from the temporary transaction table 300 to the history table 315 represents converting a requested financial transaction from a provisional status into a denied and unexecuted status. After all of the sets of transaction data have been transferred from the temporary transaction table 300, then the transaction processor 135 will export the transaction table into an ACH file that is transmitted to the partnering bank 150. This is represented by Step 525 in FIG. 5. The ACH file will be a format that is well known in the banking industry and is suitable for processing by an appropriate ACH network, such as the Federal Reserve System 155 or an Automated Clearing House 160. These steps are usually performed at the end of each banking day so that all of the financial transactions executed during that day may be processed in a single batch job. Other embodiments are contemplated, however, in which Steps 515, 520 and 525 are performed by the transaction processor 135 whenever a transaction is executed. It is contemplated that the transaction processor 135 may be configured so that the ACH files can be directly uploaded to an ACH network, thus bypassing the partnering bank 150. After these steps have been executed, the transaction processor 135 has completed all of the steps necessary to execute a financial transaction request (Step 530).

Processing of a Financial Transaction Request in the Paging Network

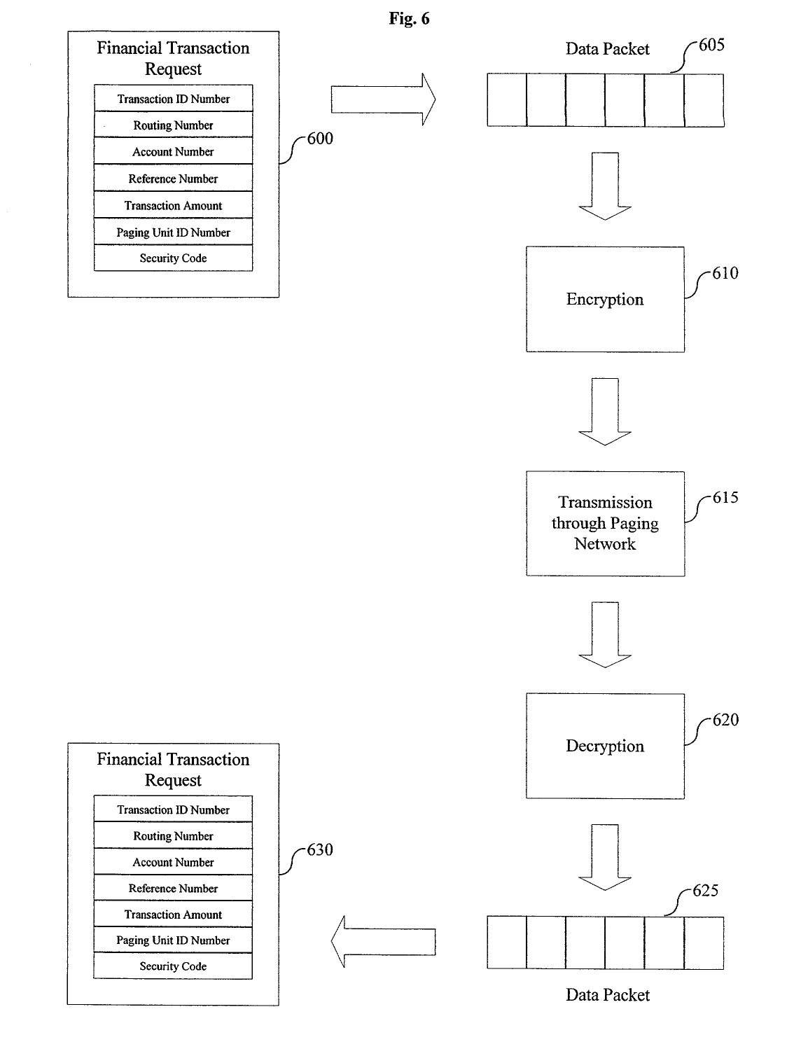

The formatting and processing of a typical financial transaction request 600 is depicted in FIG. 6. It should be noted that FIG. 6 depicts only one embodiment for a financial transaction request 600 and that the many different embodiments for the financial transaction request 600 are suitable for use with the disclosed invention. Similarly, FIG. 6 depicts only one series of steps that are suitable for processing a financial transaction request 600 and many different kinds and combinations of steps are suitable for use with the disclosed invention.

In FIG. 6, a financial transaction request 600 comprising several data fields is disclosed. These data fields include a transaction ID number, a routing number, an account number, a reference number, a transaction amount, a paging unit ID number, and a security code. This information is generally input into the two-way paging device 100 by a user desiring to execute a particular financial transaction. Specifically, the two-way paging device 100 will usually prompt the user to enter a security code or PIN in order ensure that the device 100 is not used by an unauthorized individual. Some of the data fields in the financial transaction request, however, may be automatically generated by the paging device. Before transmission by the two-way paging device, the financial transaction request data 600 will be assembled into a data packet 605 in which all of the data fields are arranged according to a specific protocol. Suitable protocols include Motorola's REFLEX® two-way paging protocols. After the data packet 605 is assembled, the data packet 605 will be encrypted to ensure that the data in the financial transaction request 600 remains secure as it is broadcast over the paging network. This encryption is represented in FIG. 6 by Step 610. After the paging message is encrypted, it is transmitted over the paging network in the same manner as any typical paging message. This is represented by Step 615 in FIG. 6. After the paging message is received at the transaction processor 135, it will be decrypted in accordance with a well-known encryption/decryption scheme. This is represented by Step 620 in FIG. 6. The decryption step 620 will produce a data packet 625 arranged in the same format as the data packet 605. This data packet 625 can then be processed by the transaction processor 135 to produce a series a data fields that comprise a financial transaction request 630 that is identical to the original request 600. The process for transmitting financial transaction information from the transaction processor 135 to the two-way paging device 100 will utilize the same steps for creating data packets and encryption as those described above.

Processing of an ACH File

The Automated Clearing House (ACH) is a payments mechanism that is used to settle credits and debits between banks. The ACH system replaces paper checks with electronic files that describe the amounts of debits and credits to be settled between banks. ACH transactions are processed through an ACH network, which may be either the Federal Reserve Network 155 or a private automated clearing house 160. The ACH system uses a batch-oriented system to settle accounts in accordance with a set of rules known as the ACH Rules. The settlement of an ACH transaction is described below with reference to FIG. 2.

An ACH transaction will generally be created by a company called an Originator. With reference to FIG. 2, it will be assumed that the Originator will be a merchant that is seeking payment for a retail transaction. The merchant will deliver a request for an ACH transaction to an Originating Depository Financial Institution (ODFI), which is the merchant account 165 in FIG. 2. The ODFI will then electronically transmit an ACH file to either the Federal Reserve Network 155 or to an automated clearing house 160 as shown in FIG. 2. This ACH file will generally be done at the end of a banking day, so that all of the day's transactions may be included. The ACH file comprises batches, with each batch representing a series of transactions pertaining to one company and one payment type. Each of these transactions are debits or credits formatted to meet National Automated Clearing House Association (NACHA) standards. Once the ACH file is received by the appropriate network, each of the transactions are sorted and transmitted to a Receiving Depository Financial Institution (RDFI). In this representative example, the RDFI is the partnering bank 150 in FIG. 2. After receiving the ACH transactions from the appropriate network, the RDFI posts the transactions to the appropriate accounts.

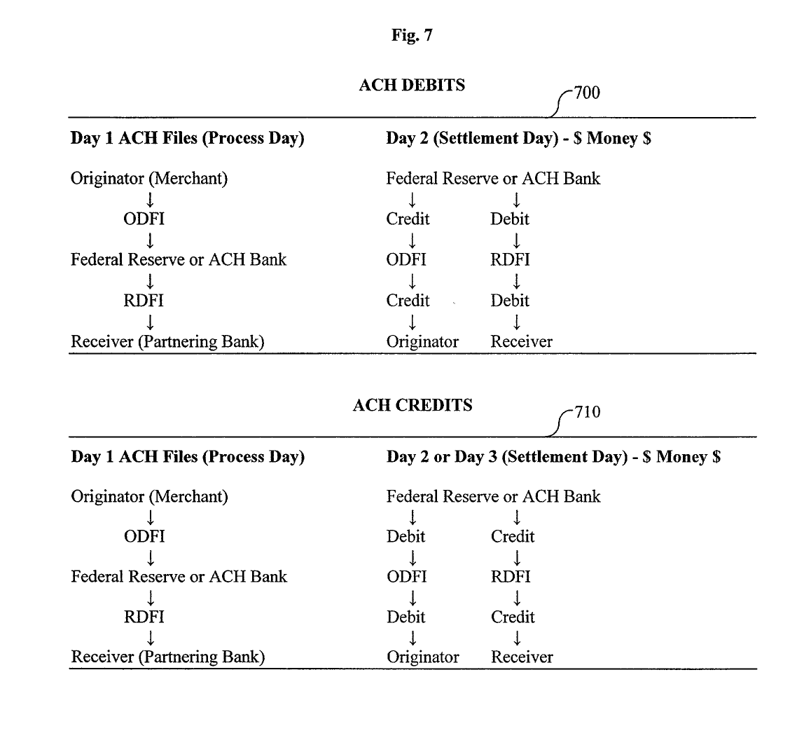

Unlike wire transfers, ACH transactions can be debits or credits and the settlement for those items are processed on different days than the day that the file is received. For example, an ACH file may be processed on day 1, but the value of that transaction will not be settled between the banks until day 2 or day 3. FIG. 7 illustrates the typical time delays for settling an ACH debit transaction 700 and an ACH credit transactions 710. With respect to an ACH debit transaction 700, FIG. 7 demonstrates that the ACH file will be transferred from the Originator to the Receiver on the first banking day. One the second banking day (i.e. the settlement day), the Federal Reserve Bank (or automatic clearing house bank) will send an appropriate value of credit to the Originator and an appropriate debit value to the Receiver. The transactions on the settlement day are done with a cash equivalent. With respect to ACH credit transactions 710, FIG. 7 demonstrates that the ACH file will be transferred from the originator to the receiver on the first banking day. For credit transactions, however, the cash values may not be settled between the banks until the second or third banking day. On the settlement day, the Federal Reserve Bank (or automatic clearing house bank) will send an appropriate debit value to the Originator and an appropriate credit value to the Receiver. Much like the debit transactions, the transactions done on the settlement day are executed with a cash equivalent.

ACH files contain groups of ACH items in batches that must be in a specific sequence or the file will not be processed by the ACH network. Most banks use an automated system for generating ACH files such as the FedLine® computer program. However, most ACH networks will accept any file that complies with the format requirements for ACH files. The following Table 1 outlines the sequence for a typical ACH file with three batches.

TABLE 1

File Header Record

| | |
|---|---|
| Batch Header Record | \| |

| | |
|---|---|
| Entry Detail Record | \| Batch 1 |
| Batch Control Record | \| |

| | |
|---|---|
| Batch Header Record | \| |

| | |
|---|---|
| Entry Detail Record | \| |
| Addenda | \| Batch 2 |
| Entry Detail Record | \| |
| Batch Control Record | \| |

| | |
|---|---|
| Batch Header Record | \| |
| Entry Detail Record | \| Batch 3 |
| Batch Control Record | \| |

File Control Record

Each ACH file includes only one File Header Record, which primarily contains ODFI information. Fields in this record include the local Federal Reserve routing number, sending point routing number, file date, file time, record block, destination name and origin name (the ODFI's name). Similarly, each batch within the ACH file will have only one Batch Header Record. Table 2 demonstrates that each ACH file may have more than one batch. Each batch within a ACH file, however, will contain similar ACH items (i.e. transactions for the same RDFI). Fields within the Batch Header Record include the ODFI routing number, company name, company entry description (which prints out on the customer statement), Originator identification, batch number, effective entry date, and standard entry class code. An Entry Detail Record is an individual ACH item or transaction. The number of Entry Detail Records per ACH file can be up to 999,999 entry records per batch. Fields with the Entry Detail Record include the dollar amount, the receiver's RDFI account number and name, the transaction code for the receiver's type of account, trace number, and RDFI routing number. The Addenda Record is an additional ACH record that is associated with an ACH Entry Detail Record. The Addenda Record carries supplemental data supporting a payment, such as remittance advice or beneficiary data. The Batch Control Record announced the end of a batch. It contains totals for the batch such as number of items, total dollar amounts, and a summation (algorithm) of account numbers. Thus, the Batch Control Record may be used for error detection and proofing in the transmission of the ACH file. Each batch must have a Batch Control Record before another batch can begin. The File Control Record is located at the end of the last batch in an ACH file. It is a control record that announces the end of the ACH file. The File Control Record also contains a summary of all of the batch control records for error checking and proofing. Further details on the formatting requirements for ACH files can be found in the Federal Reserve Publication ACH Rules.

We claim:

1. A method of processing a financial transaction request received from a paging network at a transaction processor, the transaction processor comprising a computer memory encoded with a transaction table, a temporary transaction table, and a history table, the method comprising the steps of:
receiving a financial transaction request in the form of a paging message comprising a set of transaction data;
storing the set of transaction data with an approval flag in the temporary transaction table;
retrieving a set of account data corresponding to an account number within the set of transaction data;
comparing a transaction amount from the set of transaction data with a balance amount from the corresponding set of account data to determine if sufficient funds are available for the requested financial transaction;
if sufficient funds are not available for the requested financial transaction, then performing the following steps a) through c):
a) generating a transaction denied paging message;
b) identifying a paging unit address that corresponds to a paging unit ID number within the set of transaction data;
c) sending the transaction denied paging message to the paging unit address;
if sufficient funds are available for the requested financial transaction, then performing the following steps d) through g):
d) activating the approval flag in the set of transaction data;
e) generating a transaction approved paging message comprising a plurality of data fields including an account balance data field;
f) identifying a paging unit address that corresponds to a paging unit ID number within the set of transaction data;
g) sending the transaction approved paging message to the paging unit address;
transferring all sets of transaction data in which the approval flag has been activated from the temporary transaction table to the transaction table;
transferring all sets of transaction data in which the approval flag has not been activated from the temporary transaction table to the history table; and
exporting the transaction table into an ACH file for transmission on an ACH network.

2. A method in accordance with claim 1 further comprising the steps of:
receiving a transaction approval request from a merchant through a processor network, the request comprising a plurality of data fields including a transaction amount, a routing number, an account number, and a payment address;
if sufficient funds are not available for the requested financial transaction, then performing the following steps h) through i):
h) generating a transaction denied message; and
i) sending the transaction denied message to the payment address;
if sufficient funds are available for the requested financial transaction, then performing the following steps j) through k):
j) generating a transaction approved message; and
k) sending the transaction approved message to the payment address.

3. A method in accordance in accordance with claim 1, wherein the set of transaction data further comprises a payment address, the method further comprising the steps of:
if sufficient funds are not available for the requested financial transaction, then performing the following steps h) through i):
h) generating a transaction denied message; and
i) sending the transaction denied message to the payment address;
if sufficient funds are available for the requested financial transaction, then performing the following steps i) through k):
j) generating a transaction approved message; and
k) sending the transaction approved message to the payment address.

4. A method in accordance with claim 2, wherein the payment address corresponds to a merchant's point-of-sale device.

5. A method in accordance with claim 2, wherein the payment address corresponds to a payee's two-way paging device.

6. A method in accordance with claim 3, wherein the payment address corresponds to a merchant's point-of-sale device.

7. A method in accordance with claim 3, wherein the payment address corresponds to a payee's two-way paging device.

8. A method in accordance with claim 1, wherein the paging messages are sent and received by the transaction processor in the form of e-mail messages.

9. A method in accordance with claim 1, wherein the financial transaction request represents an electronic payment request to a merchant.

10. A method in accordance with claim 1, wherein the financial transaction request represents a cash withdrawal request.

11. A method in accordance with claim 1, wherein the financial transaction request represents a balance transfer request.

12. A method of processing financial transaction requests received from a paging network with a transaction processor comprising a network interface server, a transaction server, a database server, and a message server, the method comprising the steps of:
receiving a financial transaction request in the form of an encrypted paging message at the network interface server, said paging message comprising a set of transaction data including a routing number, an account number, a transaction amount, a security code and a paging unit ID number;
decrypting the paging message at the message server;
comparing each data field within the set of transaction data with a corresponding data field standard from the database server to determine if the format of the data fields are acceptable for processing;
if any of the data fields do not have an acceptable format, then performing the following steps a) through d);
a) generating a transaction denied paging message corresponding to the reason why the transaction was denied;
b) identifying a paging unit address that corresponds to a paging unit ID number within the set of transaction data;
c) encrypting the transaction denied paging message;
d) sending the encrypted transaction denied paging message to the paging unit address
if all of the data fields have an acceptable format, then performing the following steps e) through j):
e) assigning the transaction request a transaction reference number;
f) storing the set of transaction data, the transaction reference number, and an approval flag in a temporary transaction table in the database server;
g) retrieving a set of account data and a set of customer data from the database server, both of which correspond to the account number in the set of transaction data;
h) comparing a security code from the set of transaction data with a security code from the corresponding set of customer data to determine if an acceptable security code has been provided;
i) if an acceptable security code has not been provided, then performing the transaction denied routine designated above as steps a) through d);
j) if an acceptable security code has been provided then performing the following steps l) through n):
l) comparing a transaction amount from the set of transaction data with a balance amount from the corresponding set of account data to determine if sufficient funds are available for the requested financial transaction;
m) if sufficient funds are not available for the requested financial transaction, then performing the transaction denied routine designated above as steps a) through d);
n) if sufficient funds are available for the requested financial transaction, then performing the following steps o) through s):
o) activating the approval flag in the set of transaction data;
p) generating a transaction approved paging message comprising a plurality of data fields including an account balance data field;
q) identifying a paging unit address that corresponds to a paging unit ID number within the set of transaction data;
r) encrypting the transaction approved paging message;
s) sending the encrypted transaction approved paging message to the paging unit address;
transferring all sets of transaction data in which the approval flag has been activated from the temporary transaction table to a transaction table in the database server;
transferring all sets of transaction data in which the approval flag has not been activated from the temporary transaction table to a history table in the database server; and
exporting the transaction table into an ACH file for transmission to an ACH network.

13. A method in accordance with claim 12 further comprising the steps of:
receiving a transaction approval request from a merchant through a processor network, the request comprising a plurality of data fields including a transaction amount, a routing number, an account number, and a payment address;
if sufficient funds are not available for the requested financial transaction, then performing the following steps t) through u):
t) generating a transaction denied message;
u) sending the transaction denied message to the payment address;
if sufficient funds are available for the requested financial transaction, then performing the following steps v) through w):
v) generating a transaction approved message; and
w) sending the transaction approved message to the payment address.

14. A method in accordance with claim 12, wherein the set of transaction data further comprises a payment address, the method further comprising the steps of:
if sufficient funds are not available for the requested financial transaction, then performing the following steps t) through u):
t) generating a transaction denied message;
u) sending the transaction denied message to the payment address;
if sufficient funds are available for the requested financial transaction, then performing the following steps v) through w):
v) generating a transaction approved message; and
w) sending the transaction approved message to the payment address.

15. A method in accordance with claim 13, wherein the payment address corresponds to a merchant's point-of-sale device.

16. A method in accordance with claim 13, wherein the payment address corresponds to payee's two-way paging device.

17. A method in accordance with claim 14, wherein the payment address corresponds to a merchant's point-of-sale device.

18. A method in accordance with claim 14, wherein the payment address corresponds At to payee's two-way paging device.

19. A method in accordance with claim 12, wherein the paging messages are sent and received by the transaction processor in the form of e-mail messages.

20. A method in accordance with claim 12, wherein the financial transaction request represents an electronic payment request to a merchant.

21. A method in accordance with claim 12, wherein the financial transaction request represents a cash withdrawal request.

22. A method in accordance with claim 12, wherein the financial transaction request represents a balance transfer request.

23. A method in accordance with claim 12, wherein the first and second security codes comprise four digit numbers.

24. A method in accordance with claim 12, wherein the paging messages are encrypted using a public key/private key encryption scheme.

25. A computer program product suitable for execution on a general purpose computer, the computer program product encoded with instructions for performing the following steps:
receiving a financial transaction request at the transaction processor in the form of a paging message comprising a set of transaction data;
storing the set of transaction data with an approval flag in a temporary transaction table in a database in the transaction processor;
retrieving a set of account data corresponding to an account number within the set of transaction data from the database within the transaction processor;
comparing a transaction amount from the set of transaction data with a balance amount from the corresponding set of account data to determine if sufficient funds are available for the requested financial transaction;
if sufficient funds are not available for the requested financial transaction, then performing the following steps a) through c):
a) generating a transaction denied paging message;
b) identifying a paging unit address that corresponds to a paging unit ID number within the set of transaction data;
c) sending the transaction denied paging message to the paging unit address;
if sufficient funds are available for the requested financial transaction, then performing the following steps d) through g):
d) activating the approval flag in the set of transaction data;
e) generating a transaction approved paging message comprising a plurality of data fields including an account balance data field;
f) identifying a paging unit address that corresponds to a paging unit ID number within the set of transaction data;
g) sending the transaction approved paging message to the paging unit address;
transferring all sets of transaction data in which the approval flag has been activated from the temporary transaction table to a transaction table in the database;
transferring all sets of transaction data in which the approval flag has not been activated from the temporary transaction table to a history table in the database; and
exporting the transaction table into an ACH file in the database for transmission on an ACH network.

26. A computer program product in accordance with claim 25, further encoded with instructions for performing the following steps:
receiving a transaction approval request from a merchant through a processor network, the request comprising a plurality of data fields including a transaction amount, a routing number, an account number, and a payment address;
if sufficient funds are not available for the requested financial transaction, then performing the following steps h) through i):
h) generating a transaction denied message;
i) sending the transaction denied message to the payment address;
if sufficient funds are available for the requested financial transaction, then performing the following steps j) through k):
j) generating a transaction approved message; and
k) sending the transaction approved message to the payment address.

27. A computer program product in accordance with claim 25, wherein the set of transaction data further comprises a payment address, the computer program product further encoded with instructions for performing the following steps:
if sufficient funds are not available for the requested financial transaction, then performing the following steps h) through i):
h) generating a transaction denied message;
i) sending the transaction denied message to the payment address;
if sufficient funds are available for the requested financial transaction, then performing the following steps j) through k):
j) generating a transaction approved message; and
k) sending the transaction approved message to the payment address.

28. A computer program product in accordance with claim 26, wherein the payment address corresponds to a merchant's point-of-sale device.

29. A computer program product in accordance with claim 26, wherein the payment address corresponds to payee's two-way paging device.

30. A computer program product in accordance with claim 27, wherein the payment address corresponds to a merchant's point-of-sale device.

31. A computer program product in accordance with claim 27, wherein the payment address corresponds to payee's two-way paging device.

32. A computer program product in accordance with claim 25, wherein the paging messages are sent and received by the transaction processor in the form of e-mail messages.

33. A computer program product in accordance with claim 25, wherein the financial transaction request represents an electronic payment request to a merchant.

34. A computer program product in accordance with claim 25, wherein the financial transaction request represents a cash withdrawal request.

35. A computer program product in accordance with claim 25, wherein the financial transaction request represents a balance transfer request.

36. A computer program product suitable for execution on a general purpose computer, the computer program product encoded with instructions for performing the following steps:
receiving a financial transaction request in the form of an encrypted paging, said paging message comprising a set of transaction data including a routing number, an account number, a transaction amount, a security code and a paging unit ID number;
decrypting the paging message at the message server;
comparing each data field within the set of transaction data with a corresponding data field standard from a database in the transaction processor to determine if the format of the data fields are acceptable for processing;
if any of the data fields do not have an acceptable format, then performing the following steps a) through d);
a) generating a transaction denied paging message corresponding to the reason why the transaction was denied;
b) identifying a paging unit address that corresponds to a paging unit ID number within the set of transaction data;
c) encrypting the transaction denied paging message;
d) sending the encrypted transaction denied paging message to the paging unit address
if all of the data fields have an acceptable format, then performing the following steps e) through j):
e) assigning the transaction request a transaction reference number;
f) storing the set of transaction data, the transaction reference number, and an approval flag in a temporary transaction table in the database;
g) retrieving a set of account data and a set of customer data from the database, both of which correspond to the account number in the set of transaction data;
h) comparing a security code from the set of transaction data with a security code from the corresponding set of customer data to determine if an acceptable security code has been provided;
i) if an acceptable security code has not been provided, then performing the transaction denied routine designated above as steps a) through d);
j) if an acceptable security code has been provided then performing the following steps l) through n):
l) comparing a transaction amount from the set of transaction data with a balance amount from the corresponding set of account data to determine if sufficient funds are available for the requested financial transaction;
m) if sufficient funds are not available for the requested financial transaction, then performing the transaction denied routine designated above as steps a) through d);
n) if sufficient funds are available for the requested financial transaction, then performing the following steps o) through s):
o) activating the approval flag in the set of transaction data;
p) generating a transaction approved paging message comprising a plurality of data fields including an account balance data field;
q) identifying a paging unit address that corresponds to a paging unit ID number within the set of transaction data;
r) encrypting the transaction approved paging message;
s) sending the encrypted transaction approved paging message to the paging unit address;
transferring all sets of transaction data in which the approval flag has been activated from the temporary transaction table to a transaction table in the database;
transferring all sets of transaction data in which the approval flag has not been activated from the temporary transaction table to a history table in the database; and
exporting the transaction table into an ACH file for transmission to an ACH network.

37. A computer program product in accordance with claim 36, further encoded with instructions for performing the following steps:
receiving a transaction approval request from a merchant through a processor network, the request comprising a plurality of data fields including a transaction amount, a routing number, an account number, and a payment address;
if sufficient funds are not available for the requested financial transaction, then performing the following steps t) through u):
t) generating a transaction denied message;
u) sending the transaction denied message to the payment address;
if sufficient funds are available for the requested financial transaction, then performing the following steps v) through w):
v) generating a transaction approved message; and
w) sending the transaction approved message to the payment address.

38. A computer program product in accordance with claim 36, wherein the set of transaction data further comprises a payment address, the computer program product further encoded with instructions for performing the following steps:
if sufficient funds are not available for the requested financial transaction, then performing the following steps t) through u):
t) generating a transaction denied message;
u) sending the transaction denied message to the payment address;
if sufficient funds are available for the requested financial transaction, then performing the following steps v) through w):
v) generating a transaction approved message; and
w) sending the transaction approved message to the payment address.

39. A computer program product in accordance with claim 37, wherein the payment address corresponds to a merchant's point-of-sale device.

40. A computer program product in accordance with claim 37 wherein the payment address corresponds to payee's two-way paging device.

41. A computer program product in accordance with claim 38, wherein the payment address corresponds to a merchant's point-of-sale device.

42. A computer program product in accordance with claim 38, wherein the payment address corresponds to payee's two-way paging device.

43. A computer program product in accordance with claim 36, wherein the paging messages are sent and received by the transaction processor in the form of e-mail messages.

44. A computer program product in accordance with claim 36, wherein the financial transaction request represents an electronic payment request to a merchant.

45. A computer program product in accordance with claim 36, wherein the financial transaction request represents a cash withdrawal request.

46. A computer program product in accordance with claim 36, wherein the financial transaction request represents a balance transfer request.

47. A computer program product in accordance with claim 36, wherein the first and second security codes comprise four digit numbers.

48. A computer program product in accordance with claim 36, wherein the paging messages are encrypted using a public key/private key encryption scheme.

49. A transaction processor adapted for processing financial transactions received from a paging network, the transaction processor comprising:
a network interface electrically connected to a paging network;
a transaction server electrically connected to the network interface and to a processor network, wherein the transaction server is adapted to process financial transaction requests;
a message server electrically connected the network interface and the transaction server, wherein the message server is adapted to receive inbound paging messages from the network interface, and generate outbound paging messages for transmission through the network interface to the paging network;
a database electrically connected to the transaction server and the message server, the database comprising a computer memory encoded with a relational database including an account table, a transaction table, a temporary transaction table, and a history table;
a computer memory product encoded with instructions for performing the following steps:
receiving a financial transaction request in the form of a paging message comprising a set of transaction data;
storing the set of transaction data with an approval flag in the temporary transaction table;
retrieving a set of account data corresponding to an account number within the set of transaction data from the account table;
comparing a transaction amount from the set of transaction data with a balance amount from the corresponding set of account data to determine if sufficient funds are available for the requested financial transaction;
if sufficient funds are not available for the requested financial transaction, then performing the following steps a) through c):
a) generating a transaction denied paging message;
b) identifying a paging unit address that corresponds to a paging unit ID number within the set of transaction data;
c) sending the transaction denied paging message to the paging unit address;
if sufficient funds are available for the requested financial transaction, then performing the following steps d) through g):
d) activating the approval flag in the set of transaction data;
e) generating a transaction approved paging message comprising a plurality of data fields including an account balance data field;
f) identifying a paging unit address that corresponds to a paging unit ID number within the set of transaction data;
g) sending the transaction approved paging message to the paging unit address;
transferring all sets of transaction data in which the approval flag has been activated from the temporary transaction table to a transaction table in the database;
transferring all sets of transaction data in which the approval flag has not been activated from the temporary transaction table to a history table in the database; and
exporting the transaction table into an ACH file in the database for transmission on an ACH network.

50. A transaction processor in accordance with claim 49 wherein the computer memory product is further encoded with instructions for performing the steps of:
receiving a transaction approval request from a merchant through a processor network, the request comprising a plurality of data fields including a transaction amount, a routing number, an account number, and a payment address;
if sufficient funds are not available for the requested financial transaction, then performing the following steps h) through i):
h) generating a transaction denied message;
i) sending the transaction denied message to the payment address;
if sufficient funds are available for the requested financial transaction, then performing the following steps j) through k):
j) generating a transaction approved message; and
k) sending the transaction approved message to the payment address.

51. A transaction processor in accordance with claim 49 wherein the computer memory product is further encoded with instructions for performing the steps of:
if sufficient funds are not available for the requested financial transaction, then performing the following steps h) through i):
h) generating a transaction denied message;
i) sending the transaction denied message to the payment address;
if sufficient funds are available for the requested financial transaction, then performing the following steps j) through k):
j) generating a transaction approved message; and
k) sending the transaction approved message to the payment address.

52. A transaction processor in accordance with claim 50, wherein the payment address corresponds to a merchant's point-of-sale device.

53. A transaction processor in accordance with claim 50, wherein the payment address corresponds to payee's two-way paging device.

54. A transaction processor in accordance with claim 51, wherein the payment address corresponds to a merchant's point-of-sale device.

55. A transaction processor in accordance with claim 51, wherein the payment address corresponds to payee's two-way paging device.

56. A transaction processor in accordance with claim 49, wherein the paging messages are sent and received by the message server in the form of e-mail messages.

57. A transaction processor in accordance with claim 49, wherein the financial transaction request represents an electronic payment request to a merchant.

58. A transaction processor in accordance with claim 49, wherein the financial transaction request represents a cash withdrawal request.

59. A transaction processor in accordance with claim 49, wherein the financial transaction request represents a balance transfer request.

60. A transaction processor adapted for processing financial transactions received from a paging network, the transaction processor comprising:
a network interface electrically connected to a paging network;
a transaction server electrically connected to the network interface and to a processor network, wherein the transaction server is adapted to process financial transaction requests;
a message server electrically connected the network interface and the transaction server, wherein the message server is adapted to receive inbound paging messages from the network interface, and generate outbound paging messages for transmission through the network interface to the paging network;
a database electrically connected to the transaction server and the message server, the database comprising a computer memory encoded with a relational database including an account table, a transaction table, a temporary transaction table, and a history table;
a computer memory product encoded with instructions for performing the following steps:
receiving a financial transaction request in the form of an encrypted paging message at the network interface, said paging message comprising a set of transaction data including a routing number, an account number, a transaction amount, a security code and a paging unit ID number;
decrypting the paging message at the message server;
comparing each data field within the set of transaction data with a corresponding data field standard from the database to determine if the format of the data fields are acceptable for processing;
if any of the data fields do not have an acceptable format, then performing the following steps a) through d);
a) generating a transaction denied paging message corresponding to the reason why the transaction was denied;
b) retrieving a paging unit address corresponding to a paging unit ID number within the set of transaction data from the database;
c) encrypting the transaction denied paging message;
d) sending the encrypted transaction denied paging message to the paging unit address;
if all of the data fields have an acceptable format, then performing the following steps e) through j):
e) assigning the transaction request a transaction reference number;
f) storing the set of transaction data, the transaction reference number, and an approval flag in a temporary transaction table in the database server;
g) retrieving a set of account data and a set of customer data from the database, both of which correspond to the set of transaction data;
h) comparing a security code from the set of transaction data with a security code from the corresponding set of customer data to determine if an acceptable security code has been provided;
i) if an acceptable security code has not been provided, then performing the transaction denied routine designated above as steps a) through d);
j) if an acceptable security code has been provided then performing the following steps l) through n):
l) comparing a transaction amount from the set of transaction data with a balance amount from the corresponding set of account data to determine if sufficient funds are available for the requested financial transaction;
m) if sufficient funds are not available for the requested financial transaction, then performing the transaction denied routine designated above as steps a) through d);
n) if sufficient funds are available for the requested financial transaction, then performing the following steps o) through s):
o) activating the approval flag in the set of transaction data;
p) generating a transaction approved paging message comprising a plurality of data fields including an account balance data field;
q) identifying a paging unit address that corresponds to a paging unit ID number within the set of transaction data;
r) encrypting the transaction approved paging message;
s) sending the encrypted transaction approved paging message to the paging unit address;
transferring all sets of transaction data in which the approval flag has been activated from the temporary transaction table to a transaction table in the database server;
transferring all sets of transaction data in which the approval flag has not been activated from the temporary transaction table to a history table in the database server; and
exporting the transaction table into an ACH file for transmission to an ACH network.

61. A transaction processor in accordance with claim 60 wherein the computer memory product is further encoded with instructions for performing the following steps:
receiving a transaction approval request from a merchant through a processor network, the request comprising a plurality of data fields including a transaction amount, a routing number, an account number, and a payment address;
if sufficient funds are not available for the requested financial transaction, then performing the following steps t) through u):
t) generating a transaction denied message;
u) sending the transaction denied message to the payment address;
if sufficient funds are available for the requested financial transaction, then performing the following steps v) through w):
v) generating a transaction approved message; and
w) sending the transaction approved message to the payment address.

62. A transaction processor in accordance with claim 60, wherein the set of transaction data further comprises a payment address, and wherein the computer memory product is further encoded with instructions for performing the following steps:
if sufficient funds are not available for the requested financial transaction, then performing the following steps t) through u):
t) generating a transaction denied message;
u) sending the transaction denied message to the payment address;
if sufficient funds are available for the requested financial transaction, then performing the following steps v) through w):
v) generating a transaction approved message; and
w) sending the transaction approved message to the payment address.

63. A transaction processor in accordance with claim 61, wherein the payment address corresponds to a merchant's point-of-sale device.

64. A transaction processor in accordance with claim 61, wherein the payment address corresponds to payee's two-way paging device.

65. A transaction processor in accordance with claim 62, wherein the payment address corresponds to a merchant's point-of-sale device.

66. A transaction processor in accordance with claim 62, wherein the payment address corresponds to payee's two-way paging device.

67. A transaction processor in accordance with claim 60, wherein the paging messages are sent and received by the transaction processor in the form of e-mail messages.

68. A transaction processor in accordance with claim 60, wherein the financial transaction request represents an electronic payment request to a merchant.

69. A transaction processor in accordance with claim 60, wherein the financial transaction request represents a cash withdrawal request.

70. A transaction processor in accordance with claim 60, wherein the financial transaction request represents a balance transfer request.

71. A transaction processor in accordance with claim 60, wherein the first and second security codes comprise four digit numbers.

72. A method in accordance with claim 60, wherein the paging messages are encrypted using a public key/private key encryption scheme.
